(19) United States
(12) Patent Application Publication
(10) Pub. No.: US 2026/0139535 A1
(43) Pub. Date: May 21, 2026

(54) CHARGING FLAP ARRANGEMENT FOR A MOTOR VEHICLE

(71) Applicant: BOS GmbH & Co. KG, Ostfildern (DE)

(72) Inventor: Brice HAMON, Esslingen (DE)

(21) Appl. No.: 19/377,169

(22) Filed: Nov. 3, 2025

(30) Foreign Application Priority Data
Nov. 21, 2024 (DE) 10 2024 134 321.4

(51) Int. Cl. E05F 15/614; B60L 53/16; E05B 79/20; E05B 81/06; E05B 81/18; E05B 81/30; E05B 83/34

(52) U.S. Cl. CPC E05F 15/614; B60L 53/16; E05B 79/20; E05B 81/06; E05B 81/18; E05B 81/30; E05B 83/34; E05Y 2900/534

(57) ABSTRACT

Arrangement for a vehicle, including a charging flap movable by a swivel mechanism, and securable in a closed position by a locking arrangement movably mounted by a locking mechanism, and a drive system coupled to the swivel and locking mechanisms. The drive system has a drive motor driving a gear transmission having two meshed gears associated with the swivel and with the locking mechanisms, and each is provided with a freewheel. The gears are offset from one another and at the start of a charging flap opening movement the freewheel of the gear associated with the swivel mechanism is effective and the freewheel of the gear associated with the locking mechanism is ineffective, and at the start of a charging flap closing movement the freewheel of the gear associated with the swivel mechanism is effective and the freewheel of the gear associated with the locking mechanism is ineffective.

### CROSS-REFERENCE TO RELATED APPLICATION

This claims priority from German Application No. 102024134321.4, filed Nov. 21, 2024, the disclosure of which is hereby incorporated by reference in its entirety.

### TECHNICAL FIELD

The invention relates to a charging flap arrangement for a motor vehicle, with a charging flap which is movable between a closed position and an open position by means of a swivel mechanism, wherein the charging flap is securable in its closed position by a locking arrangement which is mounted movably between a locking position and a release position by means of a locking mechanism; and with a drive system which is coupled to the swivel mechanism and to the locking mechanism in order to move the charging flap between the closed position and the open position and to move the locking arrangement between the locking position and the release position at a different time to the movement of the charging flap, and wherein the drive system has a drive motor driving a gear transmission which has two gears meshing with one another.

### BACKGROUND AND SUMMARY

A charging flap arrangement of this type is known from DE 10 2021 127 868 B4. The known charging flap arrangement has a charging flap which is mounted movably between a closed position closing an opening of the charging recess housing and an open position exposing the opening by means of a swivel mechanism having a swan neck on a charging recess housing fixed to the vehicle. Also, a locking arrangement is provided, which on the housing side is positioned on a slide which is linearly movable relative to the opening such that the locking arrangement can additionally lock the charging flap in the closed position and release it for movement into the open position. The slide on which the locking arrangement is arranged is linearly movable by means of a swivel lever and a resetting spring. The swivel lever is driven by a drive system with an electric drive motor which also swivels the swan neck of the charging flap. The swivel lever is moved by means of a gear drive, wherein a gear part is provided with teeth only over a part of its circumference. The swivel lever in turn comes into contact with a stop flank of the slide in order to move the slide. The resetting spring resets the slide into its initial position.

An object of the invention is to provide a charging flap arrangement of the type mentioned at the outset which permits easy and compact construction.

This object is achieved in that the gears are associated on the one side with the swivel mechanism and on the other side with the locking mechanism, and in that both gears are provided with a limited-angle freewheel (in the sense of free running) and are effectively offset from one another such that at the start of an opening movement the freewheel of the gear associated with the swivel mechanism is effective and the freewheel of the gear associated with the locking mechanism is ineffective, and conversely at the start of a closing movement the freewheel of the gear associated with the swivel mechanism is ineffective and the freewheel of the gear associated with the locking mechanism is effective. The solution in accordance with the invention has a particularly simple construction, since only the two gears, each provided with a freewheel, have to be driven in order to effect the required differently-timed swiveling of the charging flap on the one side and movement of the locking arrangement to secure the charging flap on the other side. The solution in accordance with the invention is suitable for charging flap arrangements of motor vehicles which are provided for closing and releasing electric charging connections. In the same way, the charging flap arrangement in accordance with the invention is suitable for closing and releasing refueling connections provided to fill the motor vehicle tank with fuels. The invention is also suitable in principle for general flap arrangements at openings of motor vehicles, so that the term charging flap arrangement must be understood generally. The locking arrangement is advantageously formed by a locking element, mounted in linearly movable manner on the charging recess housing, which in the locking position engages in a receptacle of a locking extension of the charging flap.

In one embodiment of the invention, each gear has as a freewheel a circular-arc-shaped slotted guide, coaxial to a rotary axis of the respective gear, in each of which a sliding pin engages which is co-rotating with the swivel mechanism or the locking mechanism. This results in a particularly compact construction. The respective sliding pin is preferably integrally molded in one piece to the swivel mechanism or to the locking mechanism. Advantageously, the swivel mechanism is formed by a single swan-neck-shaped swivel arm, which is fixedly connected to the charging flap and is mounted swivelably about a swivel axis fixed to the vehicle in the area of a charging recess housing. The slotted guide of each gear may be designed as a groove or slot set into a front face of the gear, or also as a web projecting above the front face of the gear. A sliding pin is of appropriate complementary design, being designed to engage in the groove or slot, or in a slide form gripping around the web. The slotted guides extend between the closed position and the open position of the charging flap preferably over a circumferential angle that corresponds to a swivel angle of the swivel mechanism. The two gears advantageously have identical toothing and identical pitch diameters, so that there is no transmission ratio or gear reduction ratio between the gears.

In a further embodiment of the invention, the locking mechanism has a crank rocker which is rotatable coaxially to the gear associated with the locking mechanism and which is mechanically coupled to the locking arrangement. The crank rocker is limited in its rotary movement relative to the gear associated with the locking mechanism.

In a further embodiment of the invention, the one sliding pin is provided at the crank rocker. Advantageously, the sliding pin co-rotating with the locking mechanism and engaging in the circular-arc-shaped slotted guide of the one gear is integrally molded in one piece with the crank rocker or fixedly connected thereto in another way.

In a further embodiment of the invention, the other sliding pin is arranged on a swivel arm rotatable coaxially to the gear associated with the swivel mechanism. This swivel arm supports the charging flap and is preferably designed swan-neck-shaped.

In a further embodiment of the invention, each freewheel has a spring arrangement that exerts a torque on the respective gear in the direction of an end position of the slotted guide. The respective spring arrangement is preferably designed as a torsion spring, wherein one leg abuts the respective sliding pin and the other leg abuts the respective gear.

In a further embodiment of the invention, the locking mechanism has a mechanical and flexible remote transmission cable coupled to the locking arrangement and to the crank rocker. The remote transmission cable is preferably a flexible transmission cable which can withstand both compression and tension. Advantageously, the remote transmission cable is designed as a Bowden cable.

In a further development of the invention, the crank rocker is joined to an actuating element mounted in linearly movable manner and on which the remote transmission cable acts. The actuating element mounted in linearly movable manner is preferably a piston which is linearly movable transversely to the crank rocker. The crank rocker acts on the actuating element by means of an equalizing element, in particular a sliding pin control.

### BRIEF DESCRIPTION OF THE DRAWINGS

Further advantages and features of the invention can be found in the claims and in the following description of a preferred example of the invention explained on the basis of the drawing.

FIG. 1 SHOWS SCHEMATICALLY IN A SECTIONAL VIEW AN embodiment of a charging flap arrangement in accordance with the invention, in the area of an outer bodywork surface of a motor vehicle, omitting various functional components of the charging flap arrangement,

FIG. 2 the charging flap arrangement according to FIG. 1 in a schematic view, including those functional components omitted in FIG. 1,

FIG. 3 the view according to FIG. 2 in a slightly different function position,

FIG. 4 the schematic view according to FIG. 3, but in a release position of a locking arrangement,

FIG. 5 the charging flap arrangement according to FIGS. 1 to 4 in a partially opened intermediate position of a charging flap and

FIG. 6 the charging flap arrangement according to FIGS. 1 to 5 in an open position of the charging flap.

### DETAILED DESCRIPTION

A motor vehicle in the form of a passenger car has in the area of a vehicle outer surface 1 an opening, not described in detail, which is adjoined by a charging recess housing 3, fixed to the vehicle, towards a vehicle interior. The charging recess housing 3 surrounds a charging connection, not shown in detail, for charging an energy storage device on the vehicle side that can supply the power for an electric drive.

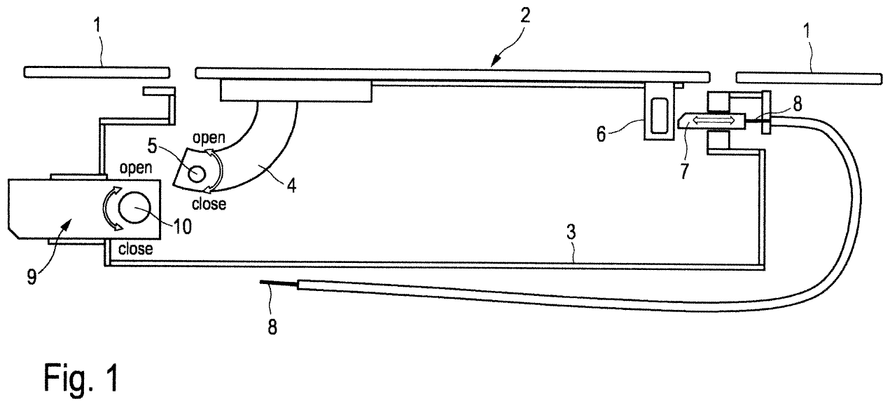

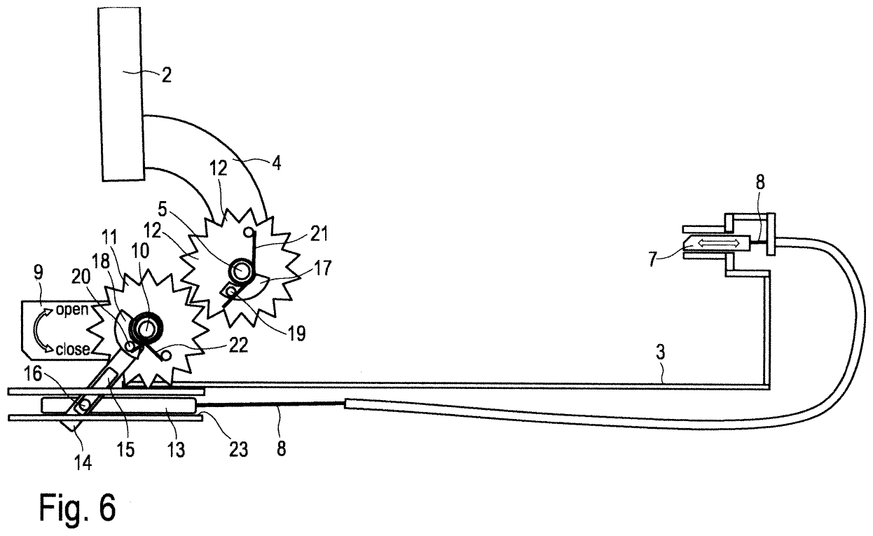

The opening in the vehicle outer surface 1 is closable by a charging flap arrangement according to FIGS. 1 to 6, described in more detail in the following. The charging flap arrangement has a charging flap 2, which in a closed position (see FIG. 1) closes the opening and is flush with the vehicle outer surface 1, i.e. the outer bodywork surface. The charging flap 2 is mounted swivelably about a swivel axis 5, fixed to the vehicle, between the closed position shown in FIG. 1 and an open position shown in FIG. 6. For swivel movement of the charging flap 2, the charging flap 2 is supported on a swivel mechanism 4, which in the example shown is designed as a swan neck-shaped swivel arm. The swivel arm is mounted swivelably about the swivel axis 5 and fixedly connected to an inner side, facing the charging recess housing 3, of the charging flap 2.

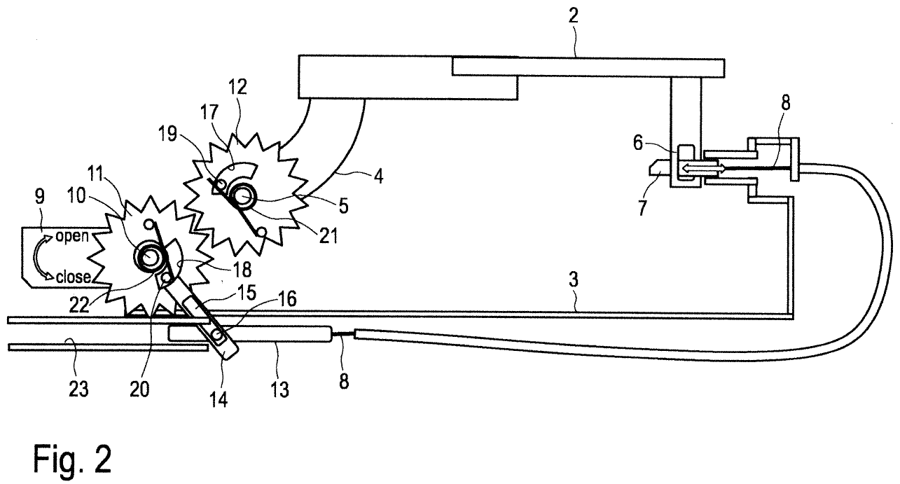

The charging flap 2 has, on a side opposite the swivel mechanism 4, a locking receptacle 6, which projects inwards from the inner side of the charging flap 2 into an interior of the charging recess housing 3. The locking receptacle 6 has a penetration through which a locking arrangement 7 can pass, in order to allow the locking receptacle 6, and hence also the charging flap 2, to be positively secured in the closed position according to FIG. 1. The locking arrangement 7 is guided in a linearly movable manner inside a linear guide, not described in detail, of the charging recess housing 3 on the side adjacent to the locking receptacle 6 of the charging flap 2—in relation to the closed position of the charging flap 2—between a locking position (FIG. 2) and a release position (FIG. 1 and FIGS. 4 to 6). A locking mechanism is provided for movement of the locking arrangement 7 between the locking position and the release position. The locking mechanism has a flexible remote transmission cable 8 in the form of a Bowden cable which can withstand both tension and compression, to permit movement of the locking arrangement 7 between the locking position and the release position. The remote transmission cable 8 is guided inside a guide sleeve, not described in detail, along the rear side of the charging recess housing 3 in the region of the underside of the charging recess housing 3. An end face, opposite the locking arrangement 7, of the remote transmission cable 8 is fixedly connected to a linearly movable actuating element 13 guided in linearly movable manner inside a linear guide 23 fixed to the housing. The linear guide 23 is fixedly connected to the charging recess housing 3 and extends parallel to a bottom of the charging recess housing 3, such that the actuating element 13 too is mounted in movable manner parallel to the bottom of the charging recess housing 3. The bottom of the charging recess housing 3 is aligned parallel to the opening in the outer bodywork surface 1.

To permit swiveling of the charging flap 2 between its closed position and its open position, and to allow movement of the locking arrangement between its release position and its locking position, the charging flap arrangement has a drive system comprising an electric drive motor 9. It may be seen from FIGS. 1 to 6 that the electric drive motor 9 has a rotatable drive axis 10 which is aligned parallel to the swivel axis 5 of the charging flap 2. The drawings explain with “open” and “close” in conjunction with circular-arc-shaped double-ended arrows the rotation direction in which on the one hand the drive axis 10 and on the other hand the swivel mechanism 4 must rotate in order to move the charging flap 2 into the open position or into the closed position.

A first spur gear, also referred to as drive gear 11, is co-rotatingly connected to the drive axis 10. This drive gear 11 meshes with a further spur gear, referred to as a swivel gear 12. The swivel gear 12 is mounted rotatably about the swivel axis 5 of the charging flap 2.

A crank rocker 14 is also mounted freely rotatably about the drive axis 10, and is coupled to a sliding pin 16 fixedly connected to the actuating element 13 by means of a slotted guide 15. A rotary movement of the crank rocker 14 leads inevitably to a linear movement of the actuating element 13, in the manner described in more detail in the following.

The spur gears, i.e. both the drive gear 11 and the swivel gear 12, are each provided with a freewheel designed in the form of a circular-arc-shaped slotted guide 17, 18. The slotted guide 18 is designed coaxial to the drive axis 10 in the drive gear 11, wherein the circular-arc-shaped slotted guide 18 extends along an end face of the drive gear 11 over a circumferential angle of slightly more than 90°. The other slotted guide 17 is designed in the same way in the swivel gear 12, wherein this slotted guide 17 too is designed in the form of a groove or slot in the swivel gear 12. The slotted guide 17 too extends coaxially to the swivel axis 5 over a circumferential angle of slightly more than 90°.

A sliding pin 20 which is fixedly connected to the crank rocker 14 projects into the slotted guide 18 of the drive gear 11. A further sliding pin 19, which is fixedly connected to the swivel mechanism 4 and hence to the charging flap 2, projects into the slotted guide 17 of the swivel gear 12.

Each spur gear, i.e. the drive gear 11 on the one hand and the swivel gear 12 on the other, is associated with a spring arrangement 22, 21 respectively, wherein each of the two spring arrangements 22, 21 is designed as a torsion spring placed coaxially onto the appropriate axis. This means that the torsion spring 22 surrounds the drive axis 10, while the torsion spring 21 surrounds the swivel axis 5. A radially projecting spring leg of the spring arrangement 21 abuts a stop, not described in detail, of the swivel gear 12. The other spring leg of the spring arrangement 21 abouts the sliding pin 19 of the swivel arm of the charging flap 2. In the spring arrangement 22, one spring leg abuts a stop, not described in detail, of the drive gear 11 in the same way, while the opposite spring leg abuts the sliding pin 20 of the crank rocker 14.

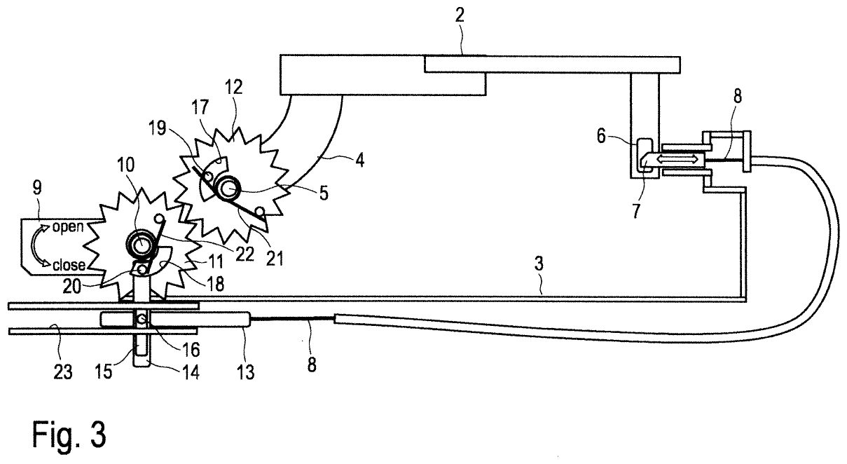

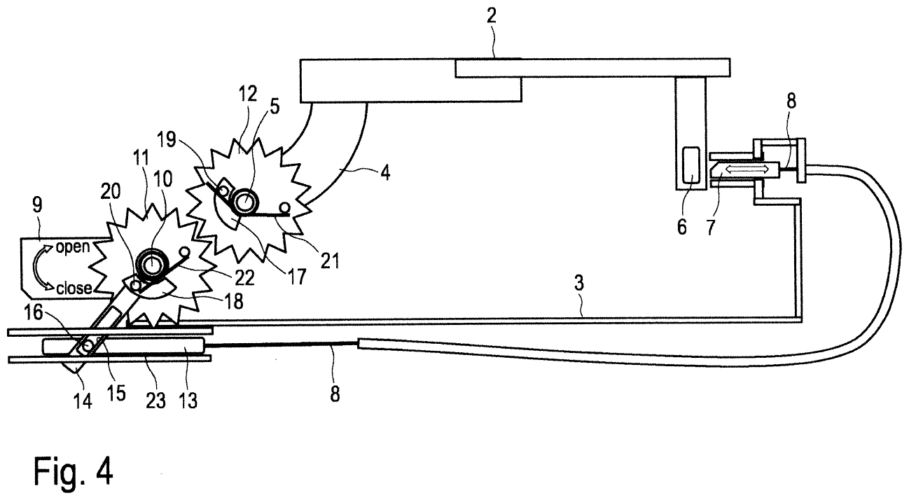

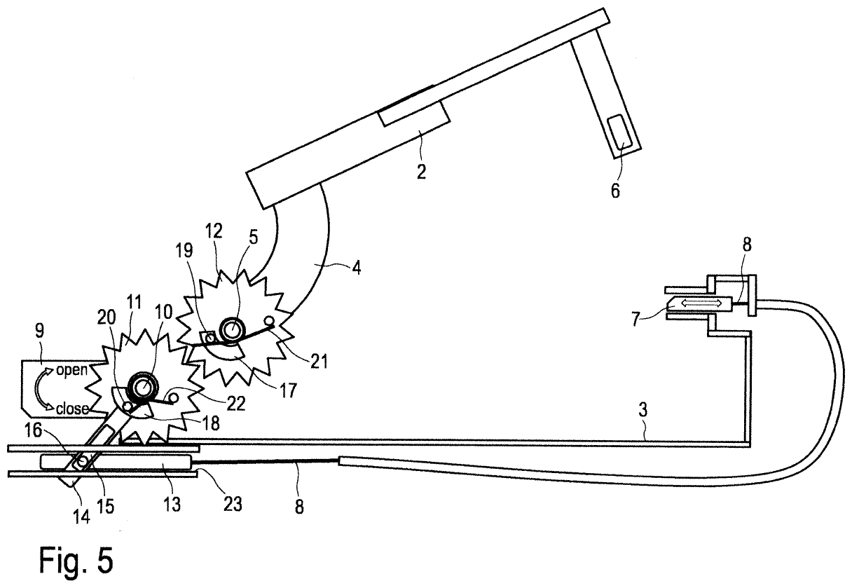

FIG. 2 shows the closed initial position of the charging flap arrangement. If, starting out from this initial position in which the charging flap 2 is in its closed position and the locking arrangement 7 is in its locking position, the drive motor 9 is now activated and the drive axis 10 rotates in the direction of “open”, then the drive gear 11 will inevitably rotate in the same direction of rotation. The spring arrangement 22 is designed such that the spring leg also moves the sliding pin 20 of the crank rocker 14 during this rotary movement of the drive gear 11. As may be seen from FIGS. 3 and 4, the sliding pin 16 of the actuating element 13 in the linear guide 23 is thereby moved leftwards in the drawing plane, so that the remote transmission cable 8 pulls the locking arrangement 7 out of the locking receptacle 6 of the charging flap 2, such that the charging flap 2 is released for an opening movement. At the same time, the drive gear 11 rotates the swivel gear 12 about the swivel axis 5 in the opposite direction due to its meshing with the spur gearing of the swivel gear 12. The swivel gear 12 here rotates in the counterclockwise direction, relative to the drawing plane, while the drive gear 11 rotates in the clockwise direction. It may be seen from FIGS. 2 to 4 that due to this rotation of the swivel gear 12, the slotted guide 17 rotates around the sliding pin 19 of the swivel mechanism 4, without the swivel mechanism 4 itself being rotated too. A further rotary movement of the swivel gear 12 in the counterclockwise direction leads to a swivel movement of the swivel mechanism 4, and hence of the charging flap 2, in the direction of the open position only after the sliding pin 19 according to FIG. 4 comes up against the end face of the slotted guide 17. At this point in time, the locking arrangement 7 has however already completely moved out of the locking receptacle 6 of the charging flap 2 (FIG. 4), such that a corresponding outward swivel movement of the charging flap 2 by the locking arrangement 7 is no longer prevented. A further rotary movement of the drive gear 11 in the clockwise direction and a corresponding opposite rotary movement of the swivel gear 12 in the counterclockwise direction now leads to the swivel mechanism 4 being moved by the sliding pin 19 in the slotted guide 17, so that the charging flap 2 is swiveled initially into the intermediate position according to FIG. 5 and then further into the open position according to FIG. 6. It may be seen from FIGS. 4 to 6 that during this further rotary movement of the drive gear 11 in the clockwise direction, the corresponding spring leg of the spring arrangement 22 supports the sliding pin 20 of the crank rocker 14, such that the slotted guide 18 rotates about this sliding pin 20, while the sliding pin 20 and hence also the crank rocker 14 remain in their end position, on the left in the drawing. As soon as the charging flap 2 has reached its open position according to FIG. 6, the drive gear 11 has rotated so far due to being driven by the drive motor 9 that the sliding pin 20 of the crank rocker 14 comes into contact with the other end of the slotted guide 18 of the drive gear 11.

The circumferential angles of the circular-arc-shaped slotted guides 17 and 18 correspond to the swivel angle of the charging flap 2 between the closed position and the open position.

If, starting out from the open position of the charging flap 2 according to FIG. 6, the charging flap 2 is to be moved back into its closed position, the drive motor 9 is driven in the reversed direction of rotation, such that the drive axis 10 and hence also the drive gear 11 rotate in the counterclockwise direction in the direction of “close”. The swivel gear 12 is here inevitably also moved and rotates accordingly in reverse in the clockwise direction. The spring arrangement 21 is designed such that the sliding pin 19 of the swivel mechanism 4 and hence of the charging flap 2 remain in contact with the end region of the slotted guide 17, such that the charging flap 2 is also moved in the closing direction during this rotary movement of the swivel gear 12 by the spring force of the spring leg of the spring arrangement 21. At the same time, the slotted guide 18 of the drive gear 11 rotates past the sliding pin 20 of the crank rocker 14, such that the spring arrangement 22 can also hold the sliding pin 20 and hence the crank rocker 14 in the left-hand end position with its corresponding spring leg. As soon as the drive gear 11 has rotated far enough (FIG. 4) for the sliding pin 20 to contact the opposite end region of the slotted guide 18 again, the crank rocker 14 can also be moved in the counterclockwise direction. At this point in time, the charging flap 2 has already reached its closed position. Further rotation of the drive gear 11 in the counterclockwise direction leads to the crank rocker 14 too being moved in the counterclockwise direction, such that the actuating element 13 is inevitably moved back into the position according to FIG. 2. The remote transmission cable 8 here inevitably pushes the locking arrangement 7 back into the locking receptacle 6 in a positive fit, such that the charging flap 2 is secured in its closed position. By comparing FIGS. 2 to 4 with one another, it may be seen that the further rotary movement of the drive gear 11 swivels only the swivel gear 12 further, so that the slotted guide 17 slides past the sliding pin 19 of the swivel mechanism 4 and the charging flap 2 in the clockwise direction, without exerting a torque on these. The corresponding spring leg of the spring arrangement 21 additionally supports the sliding pin 19. As soon as the locking arrangement 7 has moved back into its locking position, the closing process is completed and the drive motor 9 is deactivated. The drive motor 9 is controlled using an electronic control device, not shown.

1. A charging flap arrangement for a motor vehicle, comprising: with
a swivel mechanism;
a locking mechanism;
a locking arrangement, the locking arrangement being mounted movably between a locking position and a release position by the locking mechanism;
a charging flap movable between a closed position and an open position by swivel mechanism, the charging flap securable in the closed position by the locking arrangement; and
a drive system coupled to the swivel mechanism and to the locking mechanism to move the charging flap between the closed position and the open position and to move the locking arrangement between the locking position and the release position at a different time from the movement of the charging flap, the drive system having a drive motor and gear transmission having two gears meshing with one another, the drive system driving the gear transmission, one of the gears being associated with the swivel mechanism and the other of the gears is associated with the locking mechanism, each of the gears being provided with a limited-angle freewheel and offset from one another such that at the start of an opening movement of the charging flap the freewheel of the gear associated with the swivel mechanism is active and the freewheel of the gear associated with the locking mechanism is inactive, and conversely at the start of a closing movement of the charging flap the freewheel of the gear associated with the swivel mechanism is inactive and the freewheel of the gear associated with the locking mechanism is active effective.

2. The charging flap arrangement according to claim 1, wherein the freewheel of each gear comprise a circular-arc-shaped slotted guide arranged coaxial to a rotary axis of the respective gear and a sliding pin engaged in the respective slotted guide, the sliding pin co-rotating with the swivel mechanism or the locking mechanism.

3. The charging flap arrangement according to claim 2, wherein, the locking mechanism has a crank rocker rotatable coaxially to the gear associated with the locking mechanism and the crank rocker is mechanically coupled to the locking arrangement.

4. The charging flap arrangement according to claim 3, wherein one of the sliding pins is provided at the crank rocker.

5. The charging flap arrangement according to claim, wherein the other sliding pin is provided at the swivel mechanism.

6. The charging flap arrangement according to claim 2, wherein each freewheel has a spring arrangement exerting a torque on the respective sliding pin in a direction of an end position of the slotted guide.

7. The charging flap arrangement according to claim 3, wherein the locking mechanism has a mechanical and flexible remote transmission cable coupled to the locking arrangement and to the crank rocker.

8. The charging flap arrangement according to claim 7, further including an actuating element joined to the crank rocker and mounted in a linearly movable manner, and the remote transmission cable acts on the actuating element.
